(19) United States
(12) Patent Application Publication
(10) Pub. No.: US 2025/0262953 A1
(43) Pub. Date: Aug. 21, 2025

(54) POWER CONVERSION DEVICE

(71) Applicants: Hitachi Astemo, Ltd., Hitachinaka-shi (JP); HONDA MOTOR CO., LTD., Tokyo (JP)

(72) Inventors: Yoshiharu TANABE, Hitachinaka-shi (JP); Kohei NAKANO, Hitachinaka-shi (JP); Takahiro UNEME, Tokyo (JP); Ryuta WAKABAYASHI, Tokyo (JP)

(21) Appl. No.: 19/049,318

(22) Filed: Feb. 10, 2025

(30) Foreign Application Priority Data
Feb. 16, 2024 (JP) 2024-022166

(51) Int. Cl. B60L 50/51; B60L 7/16; B60L 50/60; B60L 53/22; B60L 53/24

(52) U.S. Cl. CPC B60L 50/51; B60L 7/16; B60L 50/60; B60L 53/22; B60L 53/24; B60L 2210/12; B60L 2210/14; B60L 2210/30; B60L 2210/40

(57) ABSTRACT

The power conversion device includes a plurality of electronic units that form a power conversion circuit which steps up power supplied from a high voltage battery and outputs the power to a motor, a central plate that has a flat plate-shaped partition wall portion supporting the plurality of electronic units, and a motor output connector to which the motor is connected. A pre-step-up electronic unit that is an electronic unit that handles power before step-up is disposed above the partition wall portion, and the motor output connector and a post-step-up electronic unit that is an electronic unit that handles power after step-up are disposed below the partition wall portion.

### CROSS REFERENCE TO RELATED APPLICATIONS

The present invention claims priority under 35 U.S.C. § 119 to Japanese Application No. 2024-022166, filed on Feb. 16, 2024, the entire contents of which being incorporated herein by reference.

### BACKGROUND OF THE INVENTION

### Field of the Invention

The present invention relates to a power conversion device.

### Description of Related Art

For example, Japanese Patent Application No. 5382874 discloses a power control unit including a power module. The power control unit disclosed in Japanese Patent Application No. 5382874 includes a primary side capacitor, a secondary side capacitor, and a reactor.

In addition, in the power control unit disclosed in Japanese Patent Application No. 5382874, a connection connector connected to a DC power supply, the reactor, the primary side capacitor, and the secondary side capacitor are disposed below a water jacket. In addition, a power module and a drive circuit that drives the power module are disposed above the water jacket.

Incidentally, in a power conversion device such as the power module disclosed in Japanese Patent Application No. 5382874, power supplied from a battery (DC power supply) is stepped up and then output to a motor. A power conversion circuit included in the power conversion device is formed of a plurality of electronic units, such as a capacitor unit including a capacitor, a reactor unit including a reactor, and a power module. Here, as in Japanese Patent Application No. 5382874, in a case where the electronic unit that handles the power after the step-up is separated from a motor connection AC connector connected to the motor, a bus bar that connects the electronic unit that handles the power after the step-up and the motor connection AC connector is lengthened. As a result, the power conversion device becomes larger, and inductance increases.

The present invention has been made in view of the above-described problems, and an object of the present invention is to enable shortening of a bus bar that connects an electronic unit that handles power after the step-up and a motor connection AC connector in a power conversion device that steps up power supplied from a battery and outputs the power to the motor.

### SUMMARY OF THE INVENTION

The present invention adopts the following configuration.

According to an aspect of the present invention, there is provided a power conversion device including a plurality of electronic units configured to form a power conversion circuit which steps up power supplied from a battery and outputs the power to a motor, a support plate configured to have a flat plate-shaped partition wall portion supporting the plurality of electronic units, and a motor connection AC connector to which the motor is connected, in which a pre-step-up electronic unit that is the electronic unit that handles the power before step-up is disposed above the partition wall portion, and the motor connection AC connector and a post-step-up electronic unit that is the electronic unit that handles the power after step-up are disposed below the partition wall portion.

According to the present invention, the motor connection AC connector and the post-step-up electronic unit that is the electronic unit that handles power after step-up are disposed below the partition wall portion. Therefore, in the present invention, the motor connection AC connector and the post-step-up electronic unit can be disposed close to each other, and the bus bar that connects the electronic unit that handles the power after step-up and the motor connection AC connector can be shortened.

### BRIEF DESCRIPTION OF THE DRAWINGS

FIG. 1 is a schematic configuration diagram of a vehicle on which a power conversion device according to an embodiment of the present invention is mounted.

FIG. 2 is a circuit diagram showing an electrical schematic configuration of a buck-boost converter and an inverter included in the power conversion device according to the embodiment of the present invention.

FIG. 3 is an exploded perspective view showing a schematic structural configuration of the power conversion device according to the embodiment of the present invention.

FIG. 4 is a schematic view in which an upper cover of a main body case of the power conversion device according to the embodiment of the present invention is omitted.

### DETAILED DESCRIPTION OF THE INVENTION

In the following, an embodiment of a power conversion device according to the present invention will be described with reference to the drawings.

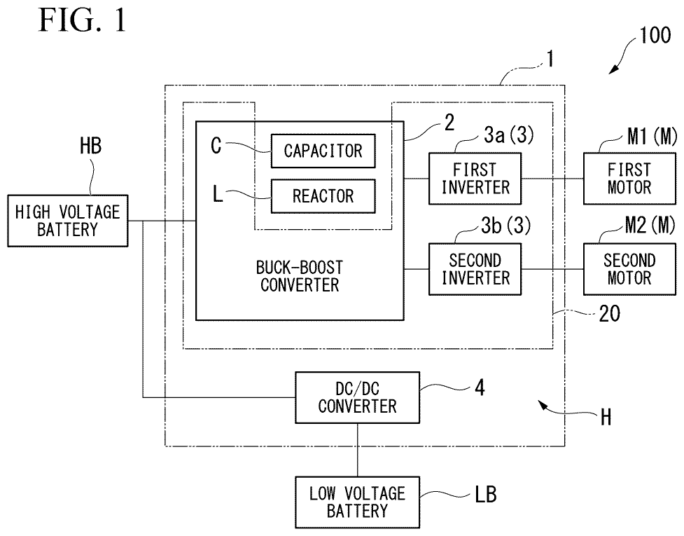

FIG. 1 is a schematic configuration diagram of a vehicle 100 on which a power conversion device 1 of the present embodiment is mounted. The vehicle 100 is, for example, an electric vehicle or a hybrid vehicle. As shown in FIG. 1, the vehicle 100 includes, for example, a high voltage battery HB, a low voltage battery LB, a motor M, and the power conversion device 1 of the present embodiment.

The high voltage battery HB is a secondary battery, such as a lithium ion battery, and outputs relatively high voltage DC power, for example, at a level of several hundred volts. The high voltage battery HB is a battery that outputs driving power supplied to the motor M and is a so-called driving battery. The low voltage battery LB is a secondary battery, such as a lead-acid battery, and outputs relatively low voltage DC power of, for example, about 12 V. The low voltage battery LB is a battery that outputs power for auxiliary devices for supplying power to auxiliary devices (not shown) and is a so-called auxiliary device battery.

The motor M generates rotational power by receiving the driving power supplied from the high voltage battery HB via the power conversion device 1. The rotational power generated by the motor M is transmitted to drive wheels of the vehicle 100 via a transmission mechanism (not shown). In the present embodiment, the motor M includes a first motor M1 and a second motor M2. For example, the first motor M1 generates power that is supplied to front wheels of the vehicle 100. In addition, for example, the second motor M2 generates the power that is supplied to rear wheels of the vehicle 100.

The power conversion device 1 of the present embodiment is a device that performs power conversion. For example, the power conversion device 1 converts DC power into AC power, converts AC power into DC power, or converts voltage. Specifically, the power conversion device 1 of the present embodiment steps up the driving power that is output from the high voltage battery HB and converts the driving power into alternating current to supply it to the motor M. In addition, the power conversion device 1 of the present embodiment converts the regenerative power that is output from the motor M into the direct current, steps down it, and supplies it to the high voltage battery HB. Further, the power conversion device 1 of the present embodiment steps down the driving power that is output from the high voltage battery HB to generate power for auxiliary devices and supplies the power for auxiliary devices to the low voltage battery LB.

As shown in FIG. 1, the power conversion device 1 of the present embodiment includes a buck-boost converter 2, an inverter 3, and a DC/DC converter 4. The buck-boost converter 2, the inverter 3, and the DC/DC converter 4 form a power conversion circuit H that performs power conversion. For example, the power conversion circuit H steps up the power supplied from the high voltage battery HB and outputs the power to the motor M.

The buck-boost converter 2 steps up or steps down the power. For example, the buck-boost converter 2 steps up the driving power supplied from the high voltage battery HB and outputs the driving power to the inverter 3. In addition, the buck-boost converter 2 in steps down the regenerative power supplied from the inverter 3 and outputs the regenerative power to the high voltage battery HB.

The inverter 3 converts the DC power into the AC power or converts the AC power into the DC power. For example, the inverter 3 converts DC driving power supplied from the buck-boost converter 2 into three-phase AC power and outputs the three-phase AC power to the motor M. In addition, the inverter 3 converts the AC regenerative power supplied from the motor M into DC power and outputs the DC power to the high voltage battery HB. In the present embodiment, the inverter 3 includes a first inverter 3a and a second inverter 3b. The first inverter 3a is connected to the first motor M1. Further, the second inverter 3b is connected to the second motor M2.

The DC/DC converter 4 steps down the driving power output from the high voltage battery HB and converts the driving power into power for auxiliary devices. The DC/DC converter 4 converts DC driving power into DC power for auxiliary devices.

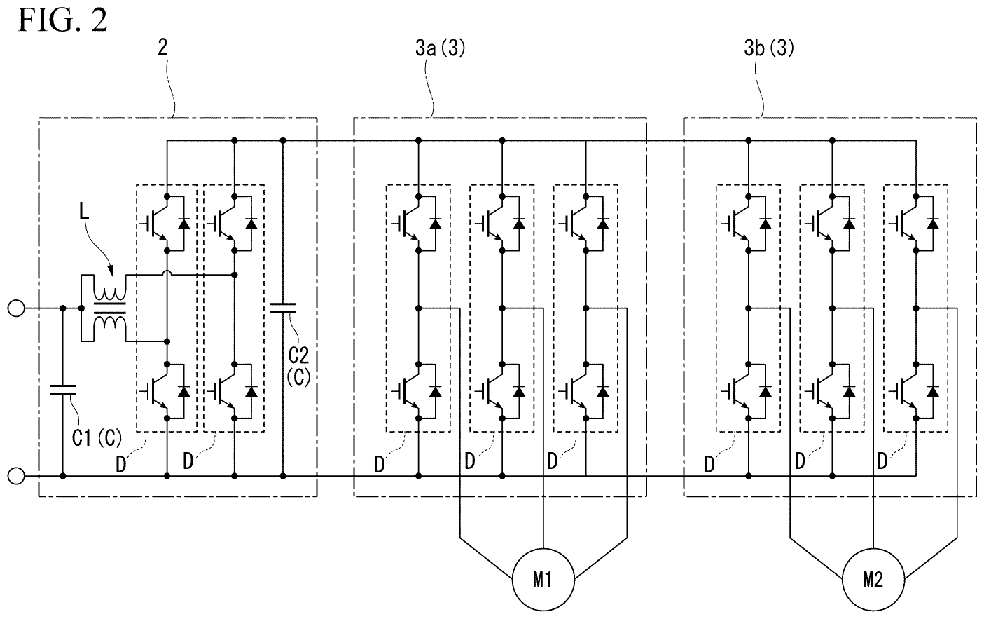

FIG. 2 is a circuit diagram showing an electrical schematic configuration of the buck-boost converter 2 and the inverter 3. As shown in FIG. 2, the power conversion device 1 of the present embodiment includes the buck-boost converter 2 and the inverter 3 connected to each other.

The buck-boost converter 2 includes two power devices D, two capacitors C, and a reactor L. One capacitor C (hereinafter, referred to as a first capacitor C1), among the two capacitors C, stores power before the step-up in a case where power is supplied from the high voltage battery HB to the motor M. In addition, the other capacitor C (hereinafter, referred to as a second capacitor C2), among the two capacitors C, stores the power after the step-up in a case where the power is supplied from the high voltage battery HB to the motor M. The first capacitor C1 and the second capacitor C2 are not limited to being formed as a single element. A plurality of elements may be used to form the first capacitor C1, or a plurality of elements may be used to form the second capacitor C2.

In addition, each inverter 3 includes three power devices D. Each power device D has a power transistor. These power transistors have semiconductor elements and are mounted on an insulating circuit substrate. In the present embodiment, one power device D includes two power transistors. However, the power device having a single power transistor may be provided. In this case, four power devices are provided in the buck-boost converter 2, and six power devices are provided in the inverter 3. For example, each power transistor includes a plurality of semiconductor elements formed of, for example, silicon carbide (SiC). The power transistor may include a semiconductor element formed of other materials such as Si (silicon) or GaN (gallium nitride).

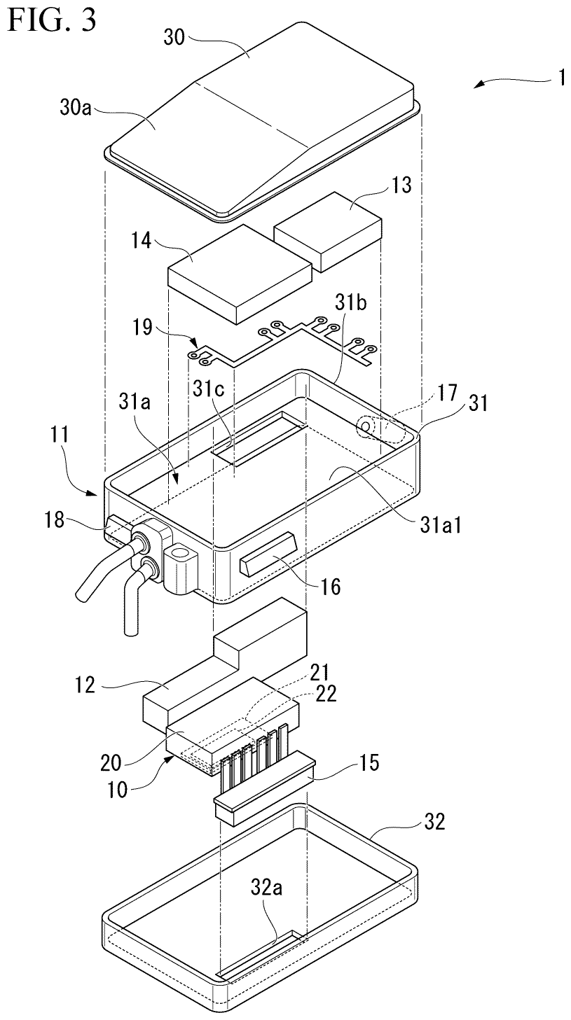

FIG. 3 is an exploded perspective view showing a schematic structural configuration of the power conversion device 1 of the present embodiment. As shown in FIG. 3, the power conversion device 1 of the present embodiment includes an intelligent power module 10, a main body case 11, a capacitor unit 12, a reactor unit 13 (electronic unit), a DC/DC converter unit 14 (electronic unit), a motor output connector 15, a DC/DC converter output connector 16 (output connector), a DC power supply connector 17, a low voltage connector 18, and an internal bus bar 19.

In the following description, for convenience of description, a direction in which the DC/DC converter unit 14 and the like are located with respect to a partition wall portion 31a of a central plate 31, which will be described later, of the main body case 11 is referred to as upward, and a direction in which the intelligent power module 10 is located with respect to the partition wall portion 31a of the central plate 31, which will be described later, of the main body case 11 is referred to as downward. However, it is also possible to change the installation posture of the power conversion device 1.

The intelligent power module 10 includes a power module 20 (electronic unit), a gate driver substrate 21 (control substrate), an ECU substrate 22 (control substrate), and the like. The power module 20 includes a plurality of power devices D having semiconductor elements, a power module case made of a resin that accommodates the power devices D, and the like. The power module 20 is an electronic unit (post-step-up electronic unit) that handles the power stepped up by the buck-boost converter 2.

The buck-boost converter 2 and the inverter 3 are formed by the power device D. A gate driver that generates a drive signal for the buck-boost converter 2 or the inverter 3 is provided in the gate driver substrate 21. Such a gate driver substrate 21 is stacked on the power module 20. An electronic control unit (ECU) that controls the gate driver substrate 21 is provided in the ECU substrate 22. The ECU substrate 22 is stacked on the gate driver substrate 21. The gate driver substrate 21 and the ECU substrate 22 may be integrated together.

The gate driver substrate 21 and the ECU substrate 22 are control substrates that control the power module 20. That is, in the present embodiment, the gate driver substrate 21 and the ECU substrate 22 control the electronic unit (post-step-up electronic unit) that handles the power stepped up by the buck-boost converter 2. However, the gate driver substrate 21 and the ECU substrate 22 are driven by the low voltage power supplied through the low voltage connector 18.

The intelligent power module 10 includes the power device D that forms the buck-boost converter 2 or the inverter 3. That is, the intelligent power module 10 forms at least part of the buck-boost converter 2 or the inverter 3.

The main body case 11 is a case that accommodates the intelligent power module 10, the capacitor unit 12, the reactor unit 13, the DC/DC converter unit 14, and the like. The main body case 11 includes an upper cover 30, the central plate 31 (support plate), and a lower cover 32. The upper cover 30, the central plate 31, and the lower cover 32 are formed to be separable in a vertical direction.

The DC/DC converter unit 14 and the reactor unit 13 are fixed to the central plate 31 from the above of the central plate 31. The upper cover 30 is a portion that covers the DC/DC converter unit 14 and the reactor unit 13 from the above of the DC/DC converter unit 14 and the reactor unit 13. That is, such an upper cover 30 is fastened to the central plate 31 via bolts (not shown) or the like.

The central plate 31 is a support plate that is located between the upper cover 30 and the lower cover 32. The central plate 31 includes a flat plate-shaped partition wall portion 31a and a surrounding wall portion 31b that is provided to surround the partition wall portion 31a from the side.

The partition wall portion 31a is disposed so that one surface (hereinafter, referred to as an upper surface 31a1) faces upward and the other surface faces downward. Such a partition wall portion 31a supports, for example, the intelligent power module 10, the capacitor unit 12, the reactor unit 13, and the DC/DC converter unit 14. The partition wall portion 31a may directly support the intelligent power module 10, the capacitor unit 12, the reactor unit 13, and the DC/DC converter unit 14, or may indirectly support the intelligent power module 10, the capacitor unit 12, the reactor unit 13, and the DC/DC converter unit 14 through other portions.

In the present embodiment, the reactor unit 13 and the DC/DC converter unit 14 are disposed above the partition wall portion 31a. In addition, in the present embodiment, the intelligent power module 10 is disposed below the partition wall portion 31a. In addition, in the present embodiment, part of the capacitor unit 12 is provided to penetrate the partition wall portion 31a in the vertical direction. Therefore, an insertion opening 31c through which the capacitor unit 12 is inserted is provided in the partition wall portion 31a.

The intelligent power module 10, the capacitor unit 12, the reactor unit 13, and the DC/DC converter unit 14 are fastened, by bolts or the like, to bosses or the like provided in the partition wall portion 31a.

A flow path for guiding a cooling liquid is provided inside the partition wall portion 31a. By flowing the cooling liquid through the flow path, the partition wall portion 31a functions as a cooling jacket, and the intelligent power module 10, the capacitor unit 12, the reactor unit 13, and the DC/DC converter unit 14 are cooled.

The surrounding wall portion 31b is provided to surround the intelligent power module 10, the capacitor unit 12, the reactor unit 13, and the DC/DC converter unit 14 from the side. The surrounding wall portion 31b is connected to an edge portion of the partition wall portion 31a and is provided to protrude upward and downward from the partition wall portion 31a. An upper end of the surrounding wall portion 31b is in contact with the upper cover 30. In addition, a lower end of the surrounding wall portion 31b is in contact with the lower cover 32.

The lower cover 32 is a portion that covers, from the downward direction, the intelligent power module 10 that is fixed to the central plate 31 from the downward direction. In addition, the lower cover 32 also covers the capacitor unit 12 from the downward direction. Such a lower cover 32 is fastened to the central plate 31 via bolts (not shown) or the like.

In addition, the lower cover 32 has an opening portion 32a for exposing the motor output connector 15. A motor side connector is mounted on the motor output connector 15 via the opening portion 32a.

The capacitor unit 12 is connected to the intelligent power module 10 and is disposed on a side of the power module 20. The capacitor unit 12 is a unit including the capacitor C provided in the buck-boost converter 2. The capacitor unit 12 includes elements that form the capacitor C and a housing that covers the elements.

In the present embodiment, the capacitor unit 12 has a first capacitor C1 that stores power before step-up and a second capacitor C2 that stores power after step-up. In the capacitor unit 12, the elements forming the first capacitor C1 are disposed inside the capacitor unit 12 to be located above the partition wall portion 31a. In addition, the elements forming the second capacitor C2 are disposed inside the capacitor unit 12 to be located below the partition wall portion 31a.

That is, in the present embodiment, the capacitor unit 12 has the first capacitor C1 and the second capacitor C2 and is disposed to penetrate the partition wall portion 31a from above to below the partition wall portion 31a. In addition, the first capacitor C1 that stores the power before step-up is disposed above the partition wall portion 31a, and the second capacitor C2 that stores the power after step-up is disposed below the partition wall portion 31a.

The reactor unit 13 is fixed to the central plate 31. The reactor unit 13 is connected to the intelligent power module 10 via a bus bar (not shown) and is disposed above the central plate 31 in the present embodiment. The reactor unit 13 is a unit including the reactor L provided in the buck-boost converter 2. The reactor unit 13 is an electronic unit (pre-step-up electronic unit) that handles power before step-up and is disposed above the partition wall portion 31a.

The DC/DC converter unit 14 is fixed to the central plate 31. The DC/DC converter unit 14 is connected to the intelligent power module 10 via a bus bar (not shown) and is disposed above the central plate 31 in the present embodiment. The DC/DC converter unit 14 is a unit forming the DC/DC converter 4 shown in FIG. 1. The DC/DC converter unit 14 is an electronic unit (pre-step-up electronic unit) that handles power before step-up and is disposed above the partition wall portion 31a.

The motor output connector 15 is a unit to which a motor side connector is connected. In the present embodiment, the motor output connector 15 is disposed below the partition wall portion 31a of the central plate 31. In addition, the motor output connector 15 is disposed further below the intelligent power module 10. Such a motor output connector 15 is connected to the power module 20 via a motor connection bus bar 40.

The DC/DC converter output connector 16 is a connector for outputting the power that is output from the DC/DC converter 4 to external auxiliary devices and the like of the power conversion device 1. The DC/DC converter output connector 16 is provided in the surrounding wall portion 31b of the central plate 31. In the present embodiment, the DC/DC converter unit 14 is disposed above the partition wall portion 31a. The DC/DC converter output connector 16 is disposed above the partition wall portion 31a, similar to the DC/DC converter unit 14.

The DC power supply connector 17 is a connector that is connected to the high voltage battery HB. The DC power supply connector 17 is provided with respect to the surrounding wall portion 31b of the central plate 31. In the present embodiment, the DC power supply connector 17 is disposed above the partition wall portion 31a.

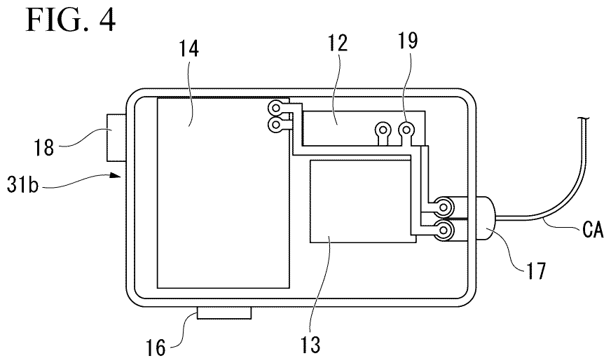

FIG. 4 is a schematic view in which the upper cover 30 of the main body case 11 is omitted. As shown in FIG. 4, in a plan view, the DC/DC converter unit 14 is located farther from the DC power supply connector 17 than the reactor unit 13. That is, in the power conversion device 1 of the present embodiment, the DC/DC converter unit 14 that handles a lower voltage than the reactor unit 13 is disposed farther from the DC power supply connector 17 than the reactor unit 13.

In addition, in the present embodiment, the power conversion device 1 is mounted on the vehicle 100 such that the reactor unit 13 is located on a rear side of the vehicle 100 and the DC/DC converter unit 14 is located on a front side of the vehicle 100. A thickness dimension of the DC/DC converter unit 14 disposed on the front side of the vehicle 100 in the vertical direction is smaller than a thickness dimension of the reactor unit 13 disposed on the rear side of the vehicle 100 in the vertical direction. Therefore, the upper cover 30 can be formed to have an inclined surface 30a (refer to FIG. 3) such that the thickness dimension of the power conversion device 1 gradually decreases from the rear side of the vehicle to the front side of the vehicle. In general, the power conversion device 1 is disposed below a curved hood of the vehicle. Since the upper cover 30 has the inclined surface 30a, it is possible to suppress interference between the power conversion device 1 and the hood, and the power conversion device 1 can be easily disposed horizontally below the hood.

The low voltage connector 18 is a connector for supplying low voltage power to the gate driver substrate 21 and the ECU substrate 22. The low voltage connector 18 is provided in the surrounding wall portion 31b of the central plate 31. In the present embodiment, the gate driver substrate 21 and the ECU substrate 22 are disposed below the partition wall portion 31a. The low voltage connector 18 is disposed below the partition wall portion 31a, similar to the gate driver substrate 21 and the ECU substrate 22.

As shown in FIG. 4, the internal bus bar 19 is disposed inside the main body case 11 (above the upper surface 31al of the partition wall portion 31a) and is a band-shaped conductor portion that connects the DC power supply connector 17, the capacitor unit 12, the reactor unit 13, and the DC/DC converter unit 14. That is, the capacitor unit 12, the reactor unit 13, and the DC/DC converter unit 14 are connected to the high voltage battery HB via the DC power supply connector 17.

In the power conversion device 1 of the present embodiment, the DC power supply connector 17 is connected to the high voltage battery HB, and the DC power is supplied from the high voltage battery HB. The power conversion device 1 steps up the DC power with the buck-boost converter 2 and converts the DC power into alternating current with the inverter 3 to supply it to the motor M. In addition, the power conversion device 1 converts the regenerative power supplied from each motor M into the DC power via the inverter 3, steps down the DC power via the buck-boost converter 2 and supplies the DC power to the high voltage battery HB. In addition, the power conversion device 1 of the present embodiment steps down the DC power supplied from the high voltage battery HB via the DC/DC converter 4 and supplies the DC power to the low voltage battery LB.

The power conversion device 1 of the present embodiment as described above includes a plurality of electronic units (in the present embodiment, the reactor unit 13, the DC/DC converter unit 14, and the power module 20) that form the power conversion circuit H that steps up power supplied from the high voltage battery HB and outputs the boosted power to the motor M. In addition, the power conversion device 1 of the present embodiment includes the central plate 31 having the flat plate-shaped partition wall portion 31a that supports the plurality of electronic units, and the motor output connector 15 to which the motor M is connected. In addition, a pre-step-up electronic unit (in the present embodiment, the reactor unit 13 and the DC/DC converter unit 14), which is an electronic unit that handles power before step-up, is disposed above the partition wall portion 31a. In addition, the motor output connector 15 and a post-step-up electronic unit (in the present embodiment, the power module 20), which is an electronic unit that handles power after step-up, are disposed below the partition wall portion 31a.

According to the power conversion device 1 of the present embodiment, the motor output connector 15 and a post-step-up electronic unit, which is the electronic unit that handles the power after step-up, are disposed below the partition wall portion 31a. Therefore, in the power conversion device 1 of the present embodiment, the motor output connector 15 and the post-step-up electronic unit can be disposed close to each other, and the motor connection bus bar 40 can be shortened.

In addition, one of the pre-step-up electronic units in the power conversion device 1 of the present embodiment is the DC/DC converter unit 14. In addition, in the power conversion device 1 of the present embodiment, the post-step-up electronic unit is the power module 20. According to the power conversion device 1 of the present embodiment, in the power conversion device 1 including the DC/DC converter unit 14 and the power module 20, it is possible to shorten the motor connection bus bar 40.

In addition, in the power conversion device 1 of the present embodiment, the DC/DC converter output connector 16 is disposed above the partition wall portion 31a. According to the power conversion device 1 of the present embodiment, the DC/DC converter unit 14 and the DC/DC converter output connector 16 can be disposed close to each other. Therefore, it is possible to shorten a wiring path for connecting the DC/DC converter unit 14 and the DC/DC converter output connector 16.

In addition, in the power conversion device 1 of the present embodiment, the power conversion circuit H includes the first capacitor C1 that stores power before step-up and the second capacitor C2 that stores power after step-up. In addition, the power conversion device 1 of the present embodiment includes the capacitor unit 12 that has the first capacitor C1 and the second capacitor C2 and that is disposed to penetrate the partition wall portion 31a from above to below the partition wall portion 31a. In addition, in the capacitor unit 12, the first capacitor C1 is disposed to be located above the partition wall portion 31a, and the second capacitor C2 is disposed to be located below the partition wall portion 31a.

According to the power conversion device 1 of the present embodiment, the first capacitor C1 and the second capacitor C2 can be made into one unit. In addition, the first capacitor C1 that stores lower voltage power than the second capacitor C2 can be accommodated in the space above the partition wall portion 31a, as in the reactor unit 13 and the DC/DC converter unit 14 that handle relatively low voltage power. In addition, the second capacitor C2 that stores higher voltage power than the first capacitor C1 can be accommodated in the space below the partition wall portion 31a, as in the power module 20 that handles relatively high voltage power. Therefore, a component that handles the relatively low voltage power and a component that handles the relatively high voltage power can be separately disposed.

In addition, the power conversion device 1 of the present embodiment includes the DC/DC converter unit 14 and the reactor unit 13 as the pre-step-up electronic unit. In addition, the DC/DC converter unit 14 has a smaller thickness dimension in the vertical direction than the reactor unit 13 and is disposed further forward of the vehicle 100 than the reactor unit 13 in a state of being mounted on the vehicle 100.

According to the power conversion device 1 of the present embodiment, even in a case where the power conversion device 1 is disposed below the curved hood of the vehicle, it is possible to suppress interference with the hood, and it is easy to dispose the power conversion device 1 horizontally below the hood.

In addition, in the power conversion device 1 of the present embodiment, the gate driver substrate 21 and the ECU substrate 22 that control the post-step-up electronic unit are disposed below the partition wall portion 31a. In addition, the gate driver substrate 21 and the ECU substrate 22 that control the post-step-up electronic unit are disposed below the partition wall portion 31a. Further, the low voltage connector 18 for supplying power to the gate driver substrate 21 and the ECU substrate 22 is disposed below the partition wall portion 31a.

According to the power conversion device 1 of the present embodiment, the low voltage connector 18 can be disposed close to the gate driver substrate 21 and the ECU substrate 22. Therefore, it is possible to shorten a wiring path for connecting the low voltage connector 18 and the gate driver substrate 21 and a wiring path for connecting the low voltage connector 18 and the ECU substrate 22.

Although the preferred embodiments of the present invention have been described above with reference to the accompanying drawings, it goes without saying that the present invention is not limited to the above embodiments. The various shapes, combinations and the like of the constituent members shown in the above-described embodiment are merely examples and can be variously changed based on design requirements and the like without departing from the gist of the present invention.

The above-described embodiments can also be described as, for example, the following appendices.

### (Appendix 1)

A power conversion device including: a plurality of electronic units configured to form a power conversion circuit which steps up power supplied from a battery and outputs the power to a motor; a support plate configured to have a flat plate-shaped partition wall portion supporting the plurality of electronic units; and a motor connection AC connector to which the motor is connected, in which a pre-step-up electronic unit that is the electronic unit that handles the power before step-up is disposed above the partition wall portion, and the motor connection AC connector and a post-step-up electronic unit that is the electronic unit that handles the power after step-up are disposed below the partition wall portion.

### (Appendix 2)

The power conversion device according to Appendix 1, in which the pre-step-up electronic unit is a DC/DC converter unit, and the post-step-up electronic unit is a power module.

### (Appendix 3)

The power conversion device according to Appendix 2, in which an output connector of the DC/DC converter unit is disposed above the partition wall portion.

### (Appendix 4)

The power conversion device according to any one of Appendices 1 to 3, in which the power conversion circuit has a first capacitor that stores the power before step-up and a second capacitor that stores the power after step-up, the power conversion device further comprises a capacitor unit that has the first capacitor and the second capacitor and that is disposed to penetrate the partition wall portion from above to below the partition wall portion, and the capacitor unit is disposed such that the first capacitor is located above the partition wall portion, and the second capacitor is located below the partition wall portion.

### (Appendix 5)

The power conversion device according to any one of Appendices 1 to 4, in which the pre-step-up electronic unit includes a DC/DC converter unit and a reactor unit, and the DC/DC converter unit has a smaller thickness dimension in a vertical direction than the reactor unit and is disposed further forward of a vehicle than the reactor unit while mounted on the vehicle.

### (Appendix 6)

The power conversion device according to any one of Appendices 1 to 5, in which a control substrate that controls the post-step-up electronic unit is disposed below the partition wall portion, and a low voltage connector for supplying power to the control substrate that controls the post-step-up electronic unit is disposed below the partition wall portion.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A power conversion device comprising:
a plurality of electronic units configured to form a power conversion circuit which steps up power supplied from a battery and outputs the power to a motor;
a support plate configured to have a flat plate-shaped partition wall portion supporting the plurality of electronic units; and
a motor connection AC connector to which the motor is connected,
wherein a pre-step-up electronic unit that is the electronic unit that handles the power before step-up is disposed above the partition wall portion, and
the motor connection AC connector and a post-step-up electronic unit that is the electronic unit that handles the power after step-up are disposed below the partition wall portion.

2. The power conversion device according to claim 1,
wherein the pre-step-up electronic unit is a DC/DC converter unit, and
the post-step-up electronic unit is a power module.

3. The power conversion device according to claim 2,
wherein an output connector of the DC/DC converter unit is disposed above the partition wall portion.

4. The power conversion device according to claim 1,
wherein the power conversion circuit has a first capacitor that stores the power before step-up and a second capacitor that stores the power after step-up,
the power conversion device further comprises a capacitor unit that has the first capacitor and the second capacitor and that is disposed to penetrate the partition wall portion from above to below the partition wall portion, and
the capacitor unit is disposed such that
the first capacitor is located above the partition wall portion, and
the second capacitor is located below the partition wall portion.

5. The power conversion device according to claim 1,
wherein the pre-step-up electronic unit includes a DC/DC converter unit and a reactor unit, and
the DC/DC converter unit has a smaller thickness dimension in a vertical direction than the reactor unit and is disposed further forward of a vehicle than the reactor unit in a state of being mounted on the vehicle.

6. The power conversion device according to claim 1,
wherein a control substrate that controls the post-step-up electronic unit is disposed below the partition wall portion, and
a low voltage connector for supplying power to the control substrate that controls the post-step-up electronic unit is disposed below the partition wall portion.
